(19) United States
(12) Patent Application Publication
(10) Pub. No.: US 2018/0370040 A1
(43) Pub. Date: Dec. 27, 2018

(54) Systems and Methods for Implementing Humanoid Balloon Robots

(71) Applicant: The Regents of the University of California, Oakland, CA (US)

(72) Inventors: Dennis W. HONG, Santa Monica, CA (US); Sepehr GHASSEMI, Los Angeles, CA (US)

(73) Assignee: The Regents of the University of California, Oakland, CA (US)

(21) Appl. No.: 15/777,515

(22) PCT Filed: Nov. 21, 2016
(86) PCT No.: PCT/US2016/063206

§ 371 Date: May 18, 2018

Related U.S. Application Data
(60) Provisional application No. 62/258,320, filed on Nov. 20, 2015.

(51) Int. Cl. B25J 11/00; A63H 27/10; A63H 11/00

(52) U.S. Cl. CPC B25J 11/0015; B25J 11/003; A63H 11/00; A63H 27/10

(57) ABSTRACT

A humanoid robot that uses lighter than air gas contained within at least one airtight bladder for stability and support is disclosed. In many embodiments, the humanoid robot includes a body and an airtight bladder associated with the body. The airtight bladder is filled with a sufficient amount of lighter than air gas to make the body buoyant in atmospheric air. In several embodiments, feet that are heavy enough to hold the body to the ground are attached to the body by legs. A variety of locomotion mechanism can be employed by humanoid robots that uses lighter than air gas contained within at least one airtight bladder can be utilized in accordance with different embodiments of the invention including mechanisms that propel the feet of the robot, and/or mechanisms that propel the body of the robot.

### CROSS REFERENCED APPLICATIONS

This application claims priority to U.S. Provisional Application 62/258,320 entitled “Systems and Method for Implementing Humanoid Balloon Robots” filed 20 November, 2015 which is hereby incorporated by reference as if set forth herewith.

### FIELD OF THE INVENTION

This invention generally relates to robots. More particularly, this invention relates to the provision of a humanoid robot using a balloon or airtight bladder and the means of locomotion for such a robot.

### BACKGROUND OF THE INVENTION

Humanoid robots have long been part of the entertainment industry. In particular, humanoid robots that have a human appearance are often portrayed in science fiction. As such, many desire to use humanoid robots for entertainment and/or educational purposes to capture the curiosity and attention of the audience. In particular, many in the entertainment industry desire to have humanoid robots move around in the environment and interact with members of the audience.

However, there are numerous problems with using current humanoid robots in an interactive environment. One problem is that the humanoid robots are often heavy as the robots require many metal and/or electrical components such as, but not limited to actuators in the knee and hip joints to walk in bipedal motion. Thus, if the robot tips or falls, the robot may harm an audience member or components in the robot may be damaged. Furthermore, components such as actuators used for walking are susceptible to break down with extended use. Thus, those skilled in the art are constantly striving to provide lighter humanoid robots with less sophisticated parts that could be deployed to move about an environment.

### SUMMARY OF THE INVENTION

The above and other problems are solved and an advance in the art is made by a robot that uses lighter than air gas for support and stability in accordance with some embodiments of the invention. In accordance with some embodiments the lighter robot that uses light than air gas for stability and control includes a body, an air bladder, a set of feet, and a set of legs. The body houses control circuitry. The airtight bladder is associated with the body is airtight and is filled with a sufficient amount of lighter than air gas to cause the body to be buoyant in atmospheric air. The set of feet include at least one foot. The combined weight of the set of feet is sufficient to anchor the body to the ground. The set of legs includes at least one leg. Each at least one leg connects one foot in the set of feet to the body in order to anchor the body to ground and allow the body to float at a neutral level.

In accordance with some embodiments, the robot that uses lighter than air gas for support and stability has a locomotion component in each foot in the set of feet. In accordance with many of these embodiments, the locomotion component in each foot in the set of feet includes motorized wheels. In a number of these embodiments, the locomotion component in each foot in the set of feet includes freely rotating wheels. In accordance with many of these embodiments, the locomotion component also includes a fan affixed to the body to propel the robot on the freely rotating wheels. In accordance with some other embodiments the robot is propelled on freely rotating wheels in each foot of the set of feet by air flows induced by fans situated in the environment.

In accordance with some embodiments, the locomotion component in each foot in the set of feet includes a spring in the foot and an actuator associated with the spring for biasing and releasing the spring.

In accordance with many embodiments, the set of legs includes a tendon connecting a foot to the base, an upper portion surrounding an upper portion of the tendon, and a lower portion surrounding a lower portion of the tendon where a gap between the upper and lower portions defines a knee joint.

In accordance with some embodiments of the invention, the robot that uses lighter than air gas for support and stability includes a winch connected to the body, and a tether having one end affixed to the winch and a second end affixed to the bladder that is external of the body wherein the winch retracts and extends the tether to cause movement of the body relative the bladder.

In accordance with some embodiments, the robot that uses lighter than air gas for support and stability includes a projector associated with one of the body and air bladder configured to project an image on a surface of one of the body and air bladder.

In accordance with many embodiments, the robot that uses lighter than air gas for support and stability includes an attachment mechanism that couples to an attachment mechanism of a retrieval system. In accordance with some of these embodiments, the attachment mechanism is on an outer surface of the air bladder. In accordance with some other embodiments, the attachment mechanism is on an outer surface of the body.

### BRIEF DESCRIPTION OF THE DRAWINGS

FIG. 1 illustrates a humanoid robot that uses lighter than air gas contained within an airtight bladder to provide support and balance in accordance with an embodiment of this invention.

FIG. 2 illustrates a robot that incorporates multiple airtight bladders containing lighter than air gas to provide support and balance.

FIG. 3 illustrates a humanoid robot that uses lighter than air gas contained within an airtight bladder to provide support and balance deployed in an environment that includes directional fans that are used to push the lighter than air robot through the environment.

FIGS. 4-7 illustrate pictures of a prototype of a humanoid robot that uses lighter than air gas contained within an airtight bladder for stability and support in accordance with an embodiment of this invention.

FIGS. 8-11 illustrate a humanoid robot that uses lighter than air gas contained within an airtight bladder for support and stability performing a jumping motion in accordance with an embodiment of this invention.

FIG. 12 illustrates a number of humanoid robots that use lighter than air gas contained within an airtight bladder for support and stability in which the airtight bladders are connected by a tether to the legs of the robot and the tethers can be extended to raise and lower the robot in accordance with embodiments of the invention.

FIGS. 13 and 14 illustrate various humanoid robots that use lighter than air gas contained within an airtight bladder in an interactive environment in which the humanoid robots can generate user interfaces via projection onto the interior surface of their airtight bladders in accordance with embodiments of the invention.

### DETAILED DESCRIPTION

Turning now to the drawings, a humanoid robot that uses lighter than air gas for support and balance as well as a means of locomotion in accordance with some embodiments of this invention is described. In accordance with many embodiments of this invention, a humanoid robot includes a body, an airtight bladder (interchangeably referred to as a balloon throughout this description), at least one leg and a foot connected to the bottom of each leg. The air tight bladder is connected to the body and holds a sufficient amount of lighter than air gas to offset the effects of gravity and suspend the body in the air in accordance with many embodiments. Each leg has one end connected to the bottom of the body and a second end connect to a foot that rests on the ground. In a number of embodiments, each foot is heavy and the combined weight of the feet tether the body suspended in the air to the ground. In accordance with several embodiments, the suspended body tends to maintain a particular neutral level in the air due to the lighter than air gas and when the body is pulled to a different level due to bipedal motion, the body naturally returns to the neutral level. In this way, the airtight bladder self corrects the body into a desired posture reducing the likelihood of the robot tipping and/or falling.

In accordance with some embodiments of the invention, the air-tight bladder is tethered to a top side of the body via a coupling line. In accordance with many embodiments, a projector may be included that is coupled to the base of the bladder and/or the body and projects a face or another appropriate user interface image on the outer wall of the bladder. In accordance with a number of embodiments, the body may house a camera and/or microphone to allow interaction between the humanoid robot and a bystander. The body of the robot can also house the control circuitry of the humanoid robot and may include wireless communication circuitry to receive commands from a remote control system.

In certain embodiments, the end of each leg has a foot attached. The feet are typically of sufficient mass to hold the upper body and airtight bladder containing the lighter than air gas at a particular neutral level when no external forces (other than gravity) are being exerted on the airtight bladder. The feet are also used to provide locomotion. In accordance with some embodiments, each foot may have wheels that protrude from the foot to roll over the ground surface. In accordance with a number of embodiments, each foot has a biasing member that may be uncoiled to apply sufficient force to the ground to cause the foot to be propelled in the air. In this way, the foot “jumps” or “hops” forward and the tethering of the airtight bladder to the foot by the humanoid robot's leg causes locomotion to be performed.

The legs in accordance some embodiments include upper and lower portions. In accordance with many of these embodiments, a knee joint is situated between the upper and lower portions of each leg. In accordance a number of these embodiments, the knees are allowed to move freely. In accordance with several embodiments, the knee has a hinge or other rotating component that allows the knee to move with one degree of freedom. In accordance with some embodiments, the knee joint may have an actuator for use in motored bipedal movement. In some embodiments, each leg includes a hip joint between the upper portion of the leg and the body. In accordance with many embodiments, the hip has a hinge or other rotating component that provides the hip joint with one or more degrees of freedom of motion. The hip joint may include an actuator in accordance a number of embodiments of the invention to facilitate motor bipedal locomotion.

In accordance with some embodiments of the invention, bipedal locomotion is provided by activating a biasing mechanism in a first foot to cause the first foot to jump forward and repeating the process with a second foot causing the second foot to move forward. The body of the humanoid robot, supported by the lighter than air airtight bladder, is pulled forward by forces transferred from the feet to the body as the feet spring forward. With each stride, the body tends to return to the particular neutral level.

In accordance with some embodiments, bipedal locomotion is provided by motorized locomotion using actuators in the knee and hip joints of the legs that move the legs forward. In accordance with a number of embodiments, the airtight bladder is tethered to the body by a tether line connected to the legs via the hips. A winch can release and retract a tether line to alter the position of the airtight bladder relative to the legs. As can readily be appreciated, allowing the airtight bladder to rise to a certain height and rapidly winching in the tether can cause the legs of the robot to rise off the ground. Coordinated correctly, the release and winching motion can be utilized to create a form of locomotion in which the legs are pulled up and swing forward mimicking a walking or hopping motion. Longer tethers can be used to raise the legs a significant height off the ground, simulating jumping. In certain embodiments, the humanoid robots can attach themselves to locations on a ceiling and the tether can be used to raise the body of the robot to attach to the ceiling and then to pull the legs of the robot up to the ceiling. Similarly, the tether can then be used to lower the legs of the robot to the ground and then to pull the body of the robot down to the ground.

In accordance with some embodiments, the feet have wheels that contact the ground surface. In accordance with many of these embodiments, the wheels are motorized to allow the feet to be moved to mimic a bipedal motion. In accordance with some other embodiments, a fan is placed on the body and used to propel the body forward pulling the legs as the feet roll on free rotating wheels.

In accordance with some embodiments, the humanoid robots are deployed in an environment including directional fans. The directional fans can be used to generate air flows that push the body supported by the airtight bladder in the direction of the air flow dragging the legs behind. In a number of embodiments, the robot does not include legs and the robot is neutrally buoyant using directional fans mounted within its environment for propulsion. In certain embodiments, the robot can incorporate active surfaces to control motion when pushed by an air current generated by a directional fan.

In accordance with several embodiments, robots are constructed from multiple airtight bladders arranged in-line with one another. In some of these embodiments, the airtight bladders are connected together via air hoses with actuated valves and/or pumps. The valves are then used to move the lighter than air gas between the bladders causing the airtight bladders and bodies to rise and fall. In several embodiments, the motion can be coordinated to cause the airtight bladders to move ahead in formation. In some other embodiments, the airtight bladder and bodies of the humanoid robots are connected by lines connect to winches. The lines are then tightened and loosened to cause the bodies to move dragging the legs and feet along with the body to mimic bipedal motion. The tethers can be tightened and loosed when the feet are propelled via another mechanism to mimic a rippling motion.

In accordance with some embodiments, the body and/or airtight bladder have a hook or handle attached that allow a hook and pulley system to be used to grab and move the robot for deployment in the environment and/or attachment to a surface such as (but not limited to) a ceiling.

These and other features and processes performed by a humanoid robot that uses lighter than air gas contained within an airtight bladder for stability and/or support in accordance with some embodiments of the invention are described below.

### Humanoid Robot Structure

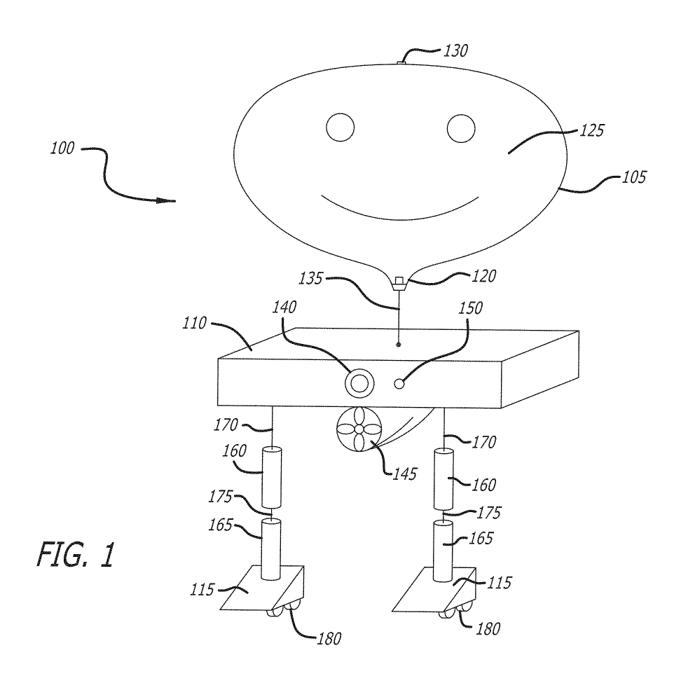

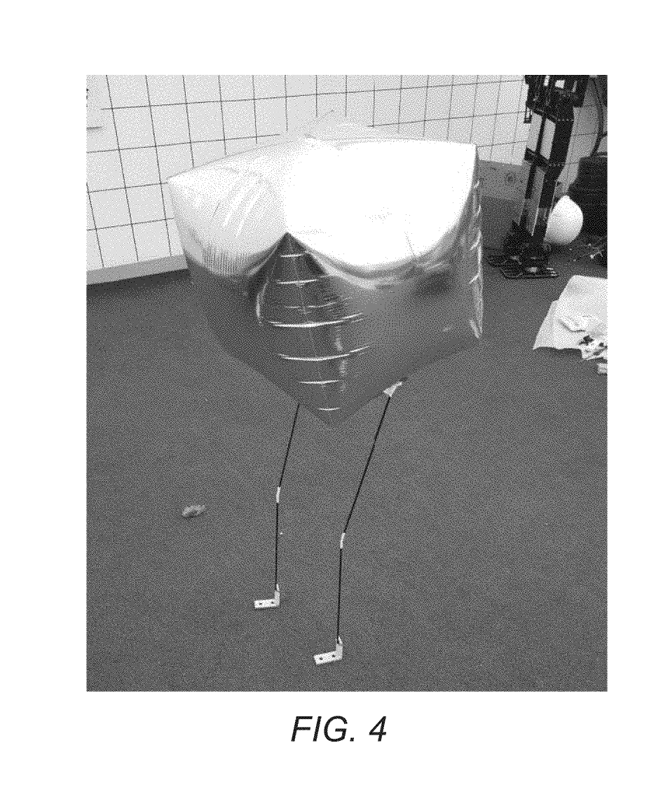

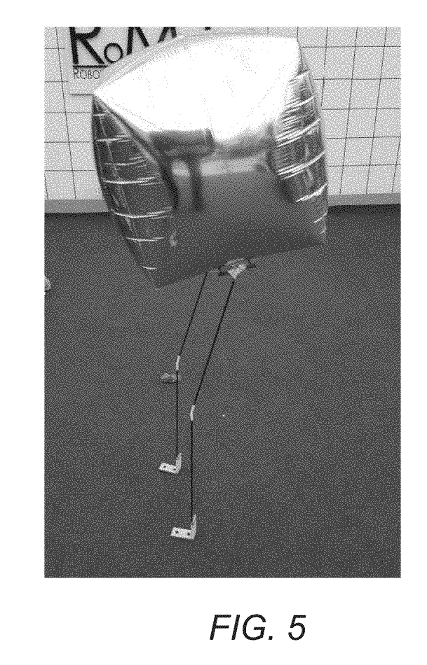

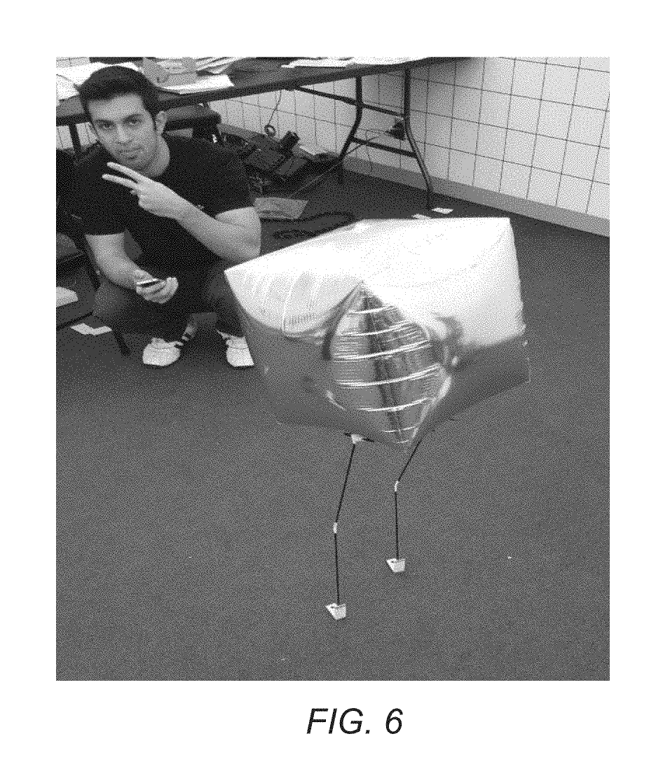

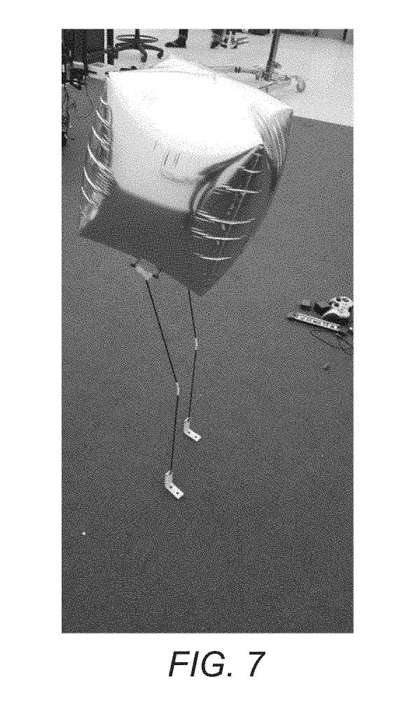

A humanoid robot that uses lighter than air gas for support and stability in accordance with an embodiment of this invention is shown in FIG. 1. Actual pictures of a humanoid robot that uses lighter than air gas for support and stability in accordance with an embodiment of this invention are shown in FIGS. 4-7. Referring back to FIG. 1, humanoid robot 100 has a body 110. In the illustrated embodiment, the body 110 is substantially cubical in shape. However, the body may be any shape in accordance with various other embodiments. The body 110 may house control circuitry components, a camera 140, a microphone 150, wireless communication circuitry, and/or any other circuitry or components needed by humanoid robot 100 to perform any desired tasks. In accordance with many embodiments, the weight of body 110 is minimized to allow the least amount of lighter than air gas possible to provide support and stability.

Airtight bladder 105 encloses an air tight compartment that houses lighter than air gas. In accordance with some embodiments, the lighter than air gas is any gas that is typically lighter than atmospheric air. In some particular embodiments, the lighter than air gas is Helium (He) as He is an inert gas that is not likely to react with other materials in the environment. The airtight bladder 105 holds a sufficient amount of lighter than air gas to make the body 110 buoyant to a predetermined amount in the atmospheric air in accordance with some embodiments. In accordance with many embodiments, the airtight bladder holds a sufficient amount of lighter than air gas to cause the body 110 to rise in the air if not tethered to the ground.

In accordance with some embodiments of the invention, an airtight bladder 105 is associated with body 110. In accordance with the shown embodiment, airtight bladder 105 is a balloon like structure that is tethered to the body 110 via line 135. The position of the tether is such that the body 110 is held in a stable position without any listing to a particular side. In accordance with a number of embodiments, the stability is provided by affixing the tether to more than one point on the body 110. Alternatively, the airtight bladder 105 may be integral to the body 110 in accordance with a number of embodiments and in accordance with some other embodiments the airtight bladder 105 is affixed under body 110. The actual positioning of the airtight bladder 105 is not important as long it causes the body 110 to be buoyant in atmospheric air and to remain in a relatively stable configuration. In accordance with some other embodiments, two or more airtight bladders that hold the same amount of lighter than air gas are affixed to opposing sides of the body 110. Furthermore, a fan 145 may be affixed to the body 110 in accordance with some embodiments for use in locomotion of the humanoid robot 100 as discussed in more detail below.

Airtight bladder 105 may have an attachment mechanism 130, such as (but not limited to) a handle, affixed to the bladder to allow a hook or other coupling component of a retrieval system to couple to the bladder. In this way, the attachment mechanism 130 can allow a retrieval system to move a humanoid robot 100 during deployment, storage, and or retrieval operations. In accordance with some other embodiments, the attachment mechanism 130 may be located on the body 110 or some other component of humanoid robot 100. As can readily be appreciated, the specific attachment mechanism and location of the attachment mechanism is largely dependent upon the requirements of a given application.

In certain embodiments, a projector 120 may be affixed to airtight bladder 105 to project a face or another appropriate user interface image onto the inner wall of the airtight bladder in such a way that the image is visible from the outside of the airtight bladder. The projector 120 can also be located in an appropriate position to project images on another part of the robot body. In accordance with some embodiments, the walls of airtight bladder 105 are semi-transparent and the projector 120 is inside the bladder 105 and projects an image 125 on the inner wall to be seen on the other wall. In accordance with a number of other embodiments, the projector 120 is on the exterior of the airtight bladder 105 and projects the image 125 on an opaque outer wall for viewing. In accordance with some of these embodiments the projector 120 may be mounted to the body to provide a better angle to project the image 125.

Feet 115 rest on the ground and are of sufficient weight to oppose the buoyancy provided by airtight bladder 105. The weight of feet 115 anchors body 110 to the ground. Furthermore each foot of feet 115 may include various components for use in locomotion in accordance with various embodiments of the invention. In the shown embodiment, each foot of feet 115 includes wheels 180 to allow wheeled locomotion. However, other locomotion components such as a biased spring member and actuators; pneumatic lifts; winches; and the like may be housed in each foot of feet 115 depending on the mode of locomotion in accordance with various other embodiments of the invention. The components that may be housed in the feet 150 and various modes of locomotion are discussed further below. In the illustrated embodiment, each foot of feet 115 is attached to the body 110 by a leg. Each leg has a tendon 170, an upper portion 160, and a lower portion 165. The tendon can be a tether made of wire or some other component that affixes to the foot and the body 110. The tendon can be held in tension at rest by the weight of the foot and buoyancy of the body 110. The upper and lower portions 160 and 165 of the legs are tubing or another structure that surround the tendon 170. In accordance with some embodiments, the upper and lower portions 160 and 165 are affixed to the tendon 170 and in accordance with some other embodiments, the upper and lower portions are not affixed to the tendon 170. In the shown embodiment, the knee joint 175 is a gap between the upper and lower portions of the legs. In accordance with other embodiments, the knee joint may be a hinge connecting the upper and lower portions. In accordance with some of these embodiments, the hinge may be movable by an actuator that is used in conjunction with a hinge and/or an actuator at the hip joint to perform a walking motion.

Various embodiments of humanoid robots are described above with reference to FIG. 1. However, other alternative embodiments of the invention may be implemented that are configured in other manners without departing from this invention. The specific configuration of a humanoid robot incorporating an airtight bladder containing lighter than air gas in accordance with many embodiments of the invention is determined based upon the requirements of a given environment in which the robot is intended to operate.

### Modes of Locomotion

In accordance with many embodiments of this invention, various different modes of locomotion may be provided including, but not limited to bipedal walking, hopping, jumping, external fan control, internal fan control, and gas transfer.

In accordance with some embodiments, a bipedal walking mode of locomotion is used. To provide bipedal walking, the humanoid robot has small legs with articulated knee and hip joints moved by actuators. In this configuration, walking can be performed by using the actuators to lift one leg which causes the equilibrium position of the robot to move forward, the robot then falls on the leg. Balance is maintained in these embodiments because the buoyancy provided by the airtight bladder causes the body of the robot to try to maintain a predetermined level. Thus, the upward lift of the lighter than air gas prevents the robot from tipping or falling during the movement. In accordance with some of these embodiments, the robot walks in a manner similar to a human on a tightrope in that the lighter than air gas in the bladder keeps the body balanced as the robot is moving preventing the robot from falling and/or tipping over.

In accordance with many embodiments, the humanoid robot moves using a hopping motion. To allow hopping, the robot has knee and hip joints that are free joints that rotate freely. Each foot then has a propulsion mechanism such as (but not limited to) a spring and actuator. When a spring and actuator is utilized as a propulsion mechanism, the spring is biased by an actuator and released. The release of the spring exerts a force on the floor that propels the foot upward and forward. As the foot is propelled upward the knee and hip joints bend giving the appearance that the robot is walking normally.

In accordance with a number of embodiments, the feet include wheels in each foot. In accordance with some of these embodiments, the wheels are motorized and may be propelled forward to move the robot. In accordance with several embodiments, the wheels are freely rotatable and a fan is incorporated into the body of the robot. The fan can operate to create an air flow that pushes the buoyant robot body forward. The body can then pull the robot legs along on the freely rotating wheels.

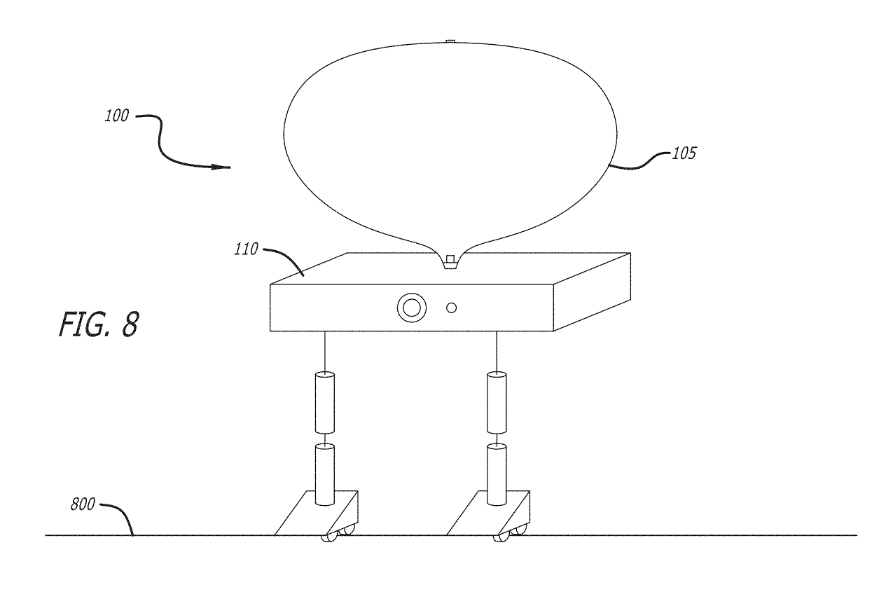

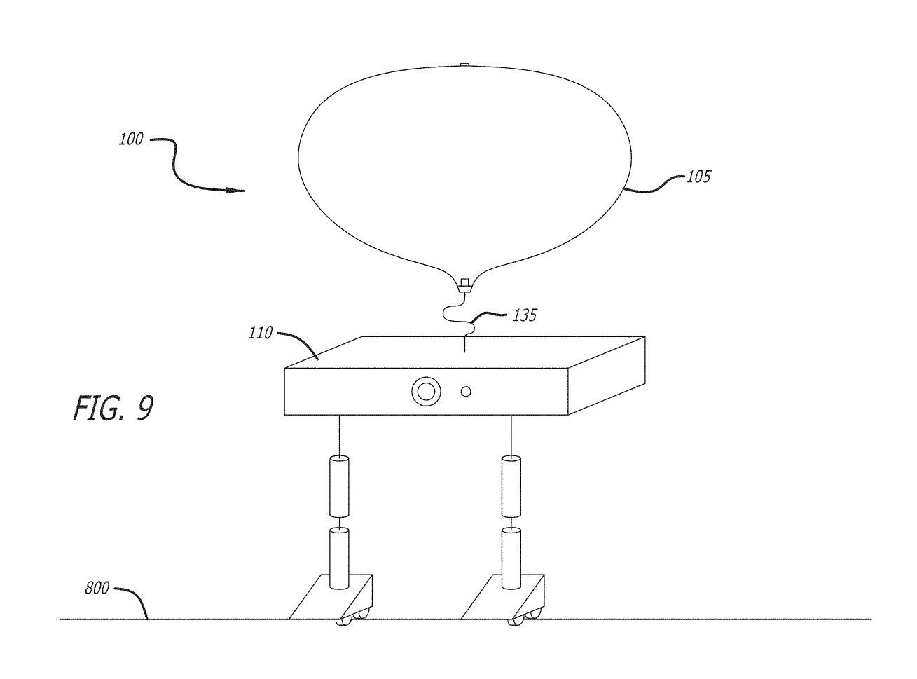

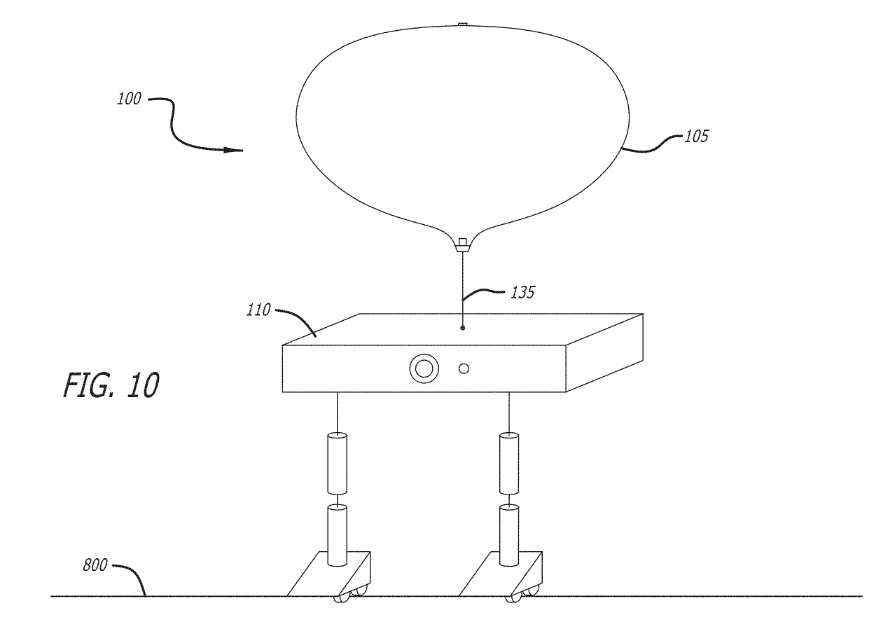

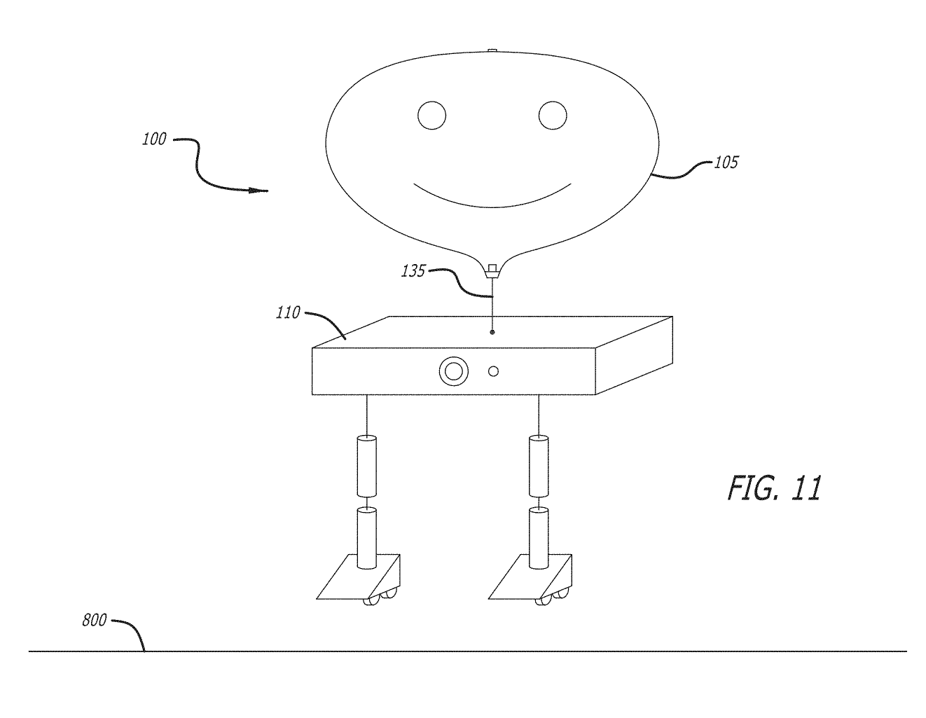

In accordance with many embodiments, a jumping motion is achieved. A process of a jumping motion performed by a humanoid robot that uses lighter than air gas for stability and support in accordance with an embodiment of this invention is shown in FIGS. 8-11. To provide the jumping motion, there is a winch connected to the tether 135 between the airtight bladder 105 and the body 110 and/or feet; and freely rotating hip and knee joints in the legs. The process begins by the winch pulling in the tether to lower the bladder 105 to the body 110 as shown in FIG. 8. The tether 135 is released by the winch so that the air bladder 105 is allowed to accelerate upward as shown in FIG. 9. The air bladder rises until the tether 135 is taunt as shown in FIG. 10. As the tether becomes taught, the force caused by the acceleration is applied to the body 110 which moves upward causing the feet to separate from the floor that in turn causes the knees and hips to rotate that gives the appearance of jumping as shown in FIG. 11. Where the acceleration of the airtight bladder is not enough to lift the feet off the ground, the winch can rapidly winch in the tether. Provided the winching is performed with enough speed, the effect of the winching will be to pull the legs of the robot up toward the airtight bladder. The ultimate result will be that the legs and airtight bladder return to the ground, however, the legs and feet may briefly leave the ground during winching creating a jumping effect. When the jump is complete, the feet then return to the ground and the humanoid robot 100 is in the original configuration shown in FIG. 10. In certain embodiments, the weight of the legs of the robot is sufficiently low that the robot can jump significant heights (e.g. several stories). In this way, the robot can raise its airtight bladder to considerable heights and then pull its legs up using a rapid winching of the tether in such a way that the legs are raised to a desired height and the feet of the robot can be deposited onto a horizontal surface at that height.

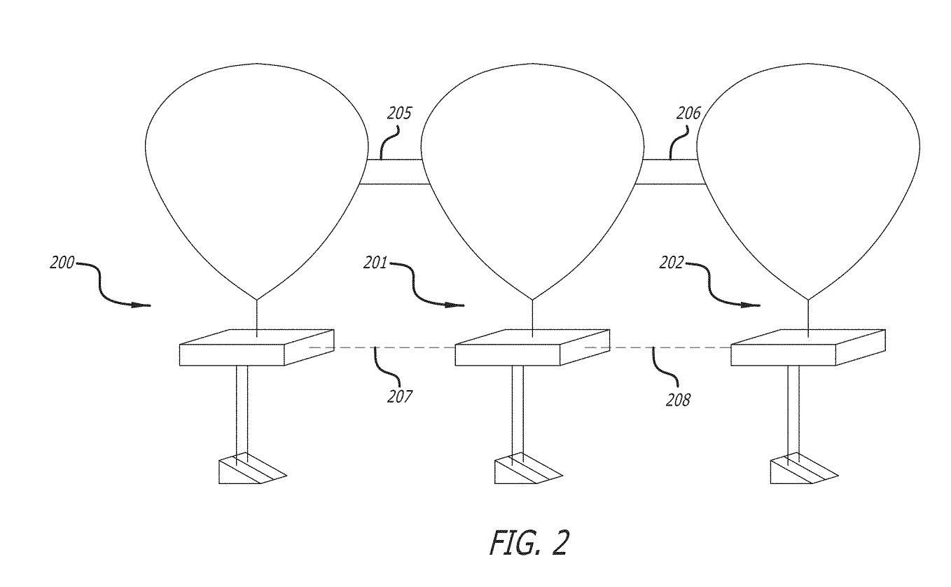

In accordance with some embodiments, a group of airtight bladders containing lighter than air gas to provide stability and support are moved in unison. The movement of the group of airtight bladders may appear to be similar to an insect or a Chinese dragon. A robot that incorporates a group of airtight bladders that contain lighter than air gas to provide stability and support and that can move in unison in accordance with an embodiment of the invention are shown in FIG. 2. In FIG. 2, airtight bladders 200-201 to which legs are affixed are positioned in-line with one another. Conduits 205 and 206 connect the airtight bladders of the adjacent airtight bladders. Inside the conduits are valves that may be opened and closed to pump air from one bladder to another. In accordance with some embodiments, the feet include freely rotating wheels. In accordance with other embodiments, the feet are light enough to allow the bladder to provide enough buoyancy to lift the feet when extra lighter than air gas is pumped into a first airtight bladder from a second airtight bladder causing the bladder to rise. The excess air can then be pumped out of the airtight bladder causing the bladder to fall and returning the feet to the ground. Repeating this sequence for the remaining airtight bladders can cause the group of airtight bladders to move forward in a rippling manner of a caterpillar or insect.

In accordance with some other embodiments, the airtight bladders are connected by tethers 207 and 208. A first airtight bladder 202 is configured to operate in the hopping manner described above while the remaining airtight bladders 200-201 are configured to have lighter feet that may float. The first airtight bladder 202 hops forward and the tether pulls the remainder of the airtight bladders 200-201 that float behind the first airtight bladder.

### External Propulsion Systems

In accordance with a number of embodiments, bursts of air from external fans are used to push the humanoid robot using lighter than air gas to provide support and stability about the room. In accordance with some of these embodiments, the humanoid robot has feet that are heavy enough to tether the humanoid robot to the ground when stationary. Yet, the feet are light enough that a force of air can push the robot causing the feet to be dragged along with the robot as it is moved by the air. In accordance with some of these embodiments, the external fans are vortex cannons that fire a burst of air to push the body and/or airtight bladder in turn causing the humanoid robot to move in the direction of the air burst. In accordance with some embodiments, the external fans may be situated through an environment and then controlled from a central control system to provide air flow from particular fans to cause a robot to move in a desired direction.

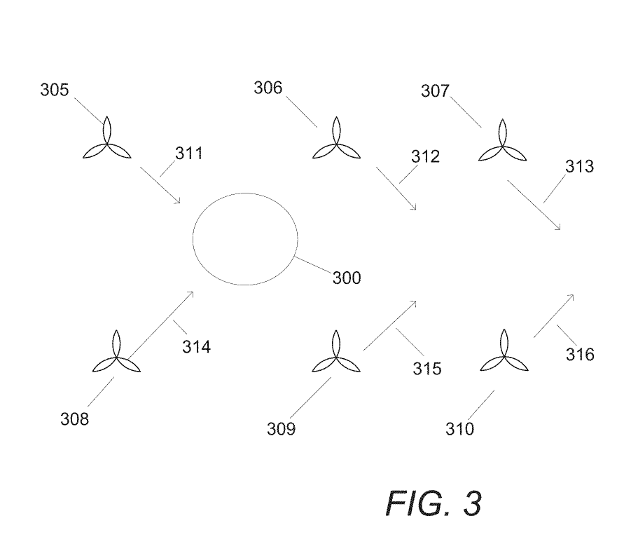

An environment including external fans for pushing a humanoid robot that use lighter than air gas contained within an airtight bladder for support and/or stability in accordance with an embodiment of the invention is shown in FIG. 3. In FIG. 3, fans 305-310 are situated throughout an environment along a defined path that a robot 300 is to travel. Each fan 305-310 may emit an air flow in directions indicated by arrows 311-316 respectively. The airflows push balloon 300 along the desired path.

Although several different modes of locomotion are described above, many other modes of locomotion may be provided in accordance with various embodiments of the invention and may depend upon the particular components included in a humanoid robot using lighter than air gas for support and stability and the particular task the robot is to perform.

Humanoid Robots that Use Lighter than Air Gas within an Operating Environment

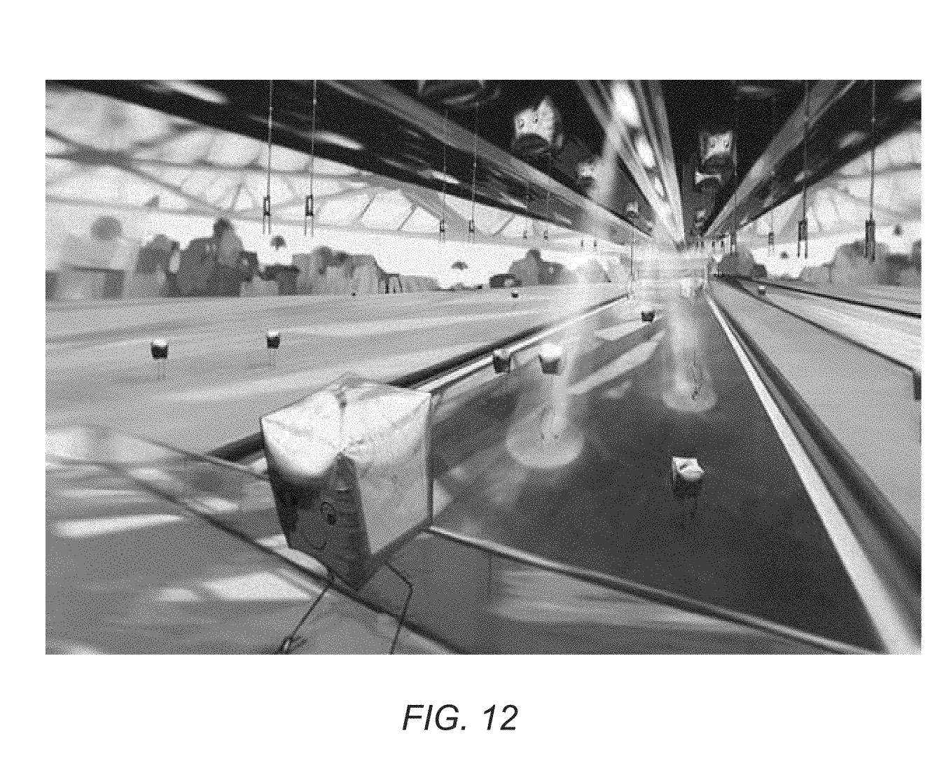

A variety of humanoid robots that use lighter than air gas contained within an airtight bladder for support and/or stability within different operating environments in accordance with embodiments of the invention are illustrated in FIGS. 12-14. A number of humanoid robots implemented in accordance with an embodiment of the invention in which the humanoid robots can raise or lower bodies incorporating airtight bladders using tethers are illustrated in FIG. 12. The robots shown in FIG. 12 include humanoid robots that stored by attaching themselves to the ceiling. The robots can be deployed by lowering the body of the robot to the ground using a tether and then pulling the body of the robot containing the airtight bladder down to the ground using a winching mechanism to reel in the tether. The winches and tethers can also be utilized to perform any of the variety of functions described above. The humanoid robots illustrated in FIG. 12 also project a variety of user interfaces including map information. In certain embodiments, a user can “summon” a humanoid robot using an application installed upon a mobile phone or another computing device. The humanoid robot can have a personality and/or appearance that is configured by the user. In certain embodiments, any robot can be “summoned” and the control electronics of the humanoid robot controls the user interface projected by the robot to provide the robot with the personality and/or appearance created by the user.

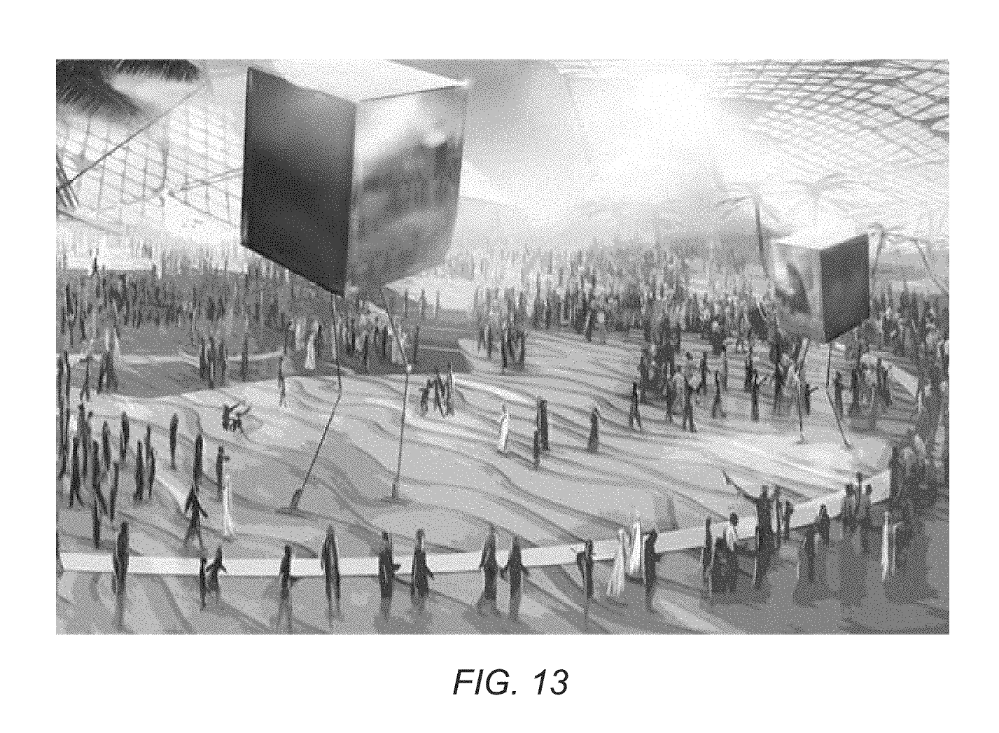

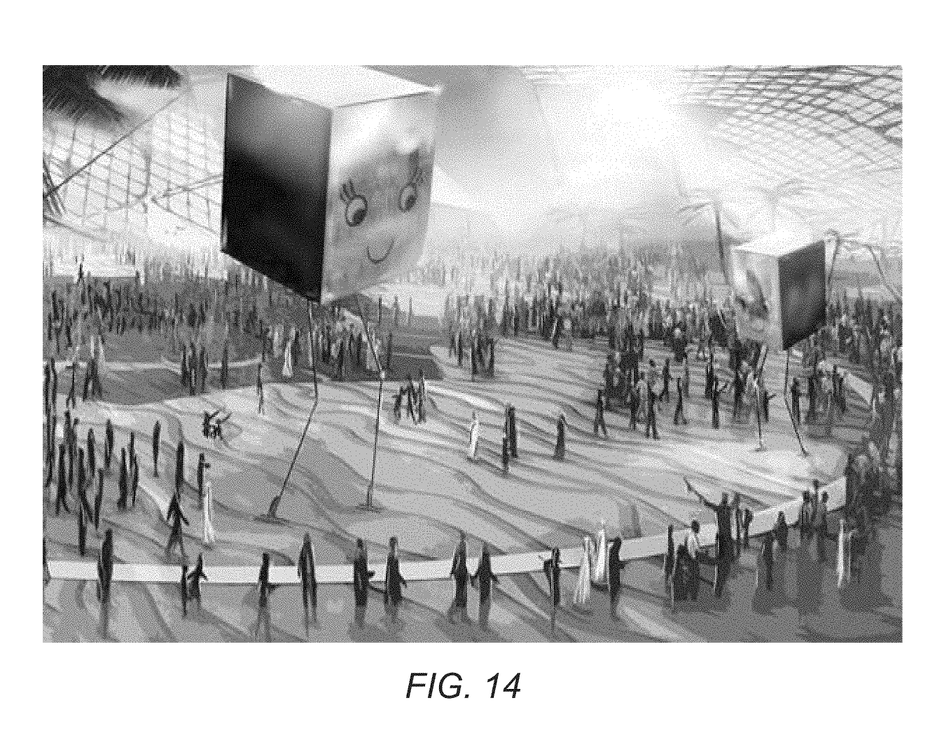

While a number of the humanoid robots illustrated and described above have bodies that are smaller than that of a typical human, robots incorporating much larger bodies and/or airtight bladders in accordance with several embodiments of the invention are illustrated in FIGS. 13 and 14. As can readily be appreciated, the larger size of the illustrated robots enables the projection of larger user interface display images. Furthermore, humanoid robots in accordance with embodiments of the invention are not limited to the shapes illustrated and described above. Any of a variety of shapes appropriate to the requirements of specific applications can be utilized in accordance with embodiments of the invention including (but not limited to) provision of light weight manipulators and/or other mechanical structures that assist the robot in performing desired functions.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A robot that uses lighter than air gas for support and stability comprising:
a body that houses control circuitry;
an airtight bladder associated with the body that is airtight and is filled with a sufficient amount of lighter than air gas to cause the body to be buoyant in atmospheric air;
a set of feet including at least one foot, the combined weight of the set of feet is sufficient to anchor the body to the ground; and
a set of legs including at least one leg where each of the at least one leg connects one foot in the set of feet to the body to anchor the body to ground and allow the body to float at a neutral level.

2. The robot that uses lighter than air gas for support and stability of claim 1 further comprising a locomotion component in each foot in the set of feet.

3. The robot that uses lighter than air gas for support and stability of claim 2 wherein the locomotion component in each foot in the set of feet comprises motorized wheels.

4. The robot that uses lighter than air gas for support and stability of claim 2 wherein the locomotion component in each foot in the set of feet comprises freely rotating wheels.

5. The robot that uses lighter than air gas for support and stability of claim 4 further comprising a fan affixed to the body to propel the robot on the freely rotating wheels.

6. The robot that uses lighter than air gas for support and stability of claim 4 wherein the robot is propelled on freely rotating wheels in each foot of the set of feet by air flows induced by fans situated in the environment.

7. The robot that uses lighter than air gas for support and stability of claim 2 wherein the locomotion component in each foot in the set of feet comprises a spring in the foot and an actuator associated with the spring for biasing and releasing the spring.

8. The robot that uses lighter than air gas for support and stability of claim 1 wherein each leg in the set of legs comprises:
a tendon connecting a foot to the base;
an upper portion surrounding an upper portion of the tendon; and
a low portion surrounding a lower portion of the tendon where a gap between the upper and lower portions defines a knee joint.

9. The robot that uses lighter than air gas for support and stability of claim 1, further comprising:
a winch connected to the body;
a tether having one end affixed to the winch and a second end affixed to the bladder that is external of the body wherein the winch retracts and extends the tether to cause movement of the body relative the bladder.

10. The robot that uses lighter than air gas for support and stability comprising:
a projector associated with one of the body and air bladder configured to project an image on a surface of one of the body and air bladder.

11. The robot that uses lighter than air gas for support and stability of claim 1 comprising: an attachment mechanism that couples to an attachment mechanism of a retrieval system.

12. The robot that uses lighter than air gas for support and stability of claim 11 wherein the attachment mechanism is on an outer surface of the air bladder.

13. The robot that uses lighter than air gas for support and stability of claim 11 wherein the attachment mechanism is on an outer surface of the body.

14. A method for providing locomotion in a robot that uses lighter than air gas for support and stability having a body that houses control circuitry, an airtight bladder associated with the body that is airtight and is filled with a sufficient amount of lighter than air gas to cause the body to be buoyant in atmospheric air, a set of feet including at least one foot, the combined weight of the set of feet is sufficient to anchor the body to the ground, and a set of legs including at least one leg where each at least one leg connects one foot in the set of feet to the body to anchor the body to ground and allow the body to float at a neutral level where each foot in the set of feet comprises a spring in the foot and an actuator associated with the spring for biasing and releasing the spring, the method comprising:
biasing the spring in a coiled position;
releasing the spring in one foot causing a force to be exerted on the surface propelling the foot into the air in a forward direction; and
allowing the foot to land on the ground;

15. The method of claim 14 wherein each leg in the set of legs comprises a tendon connecting a foot to the base, an upper portion surrounding an upper portion of the tendon, and a low portion surrounding a lower portion of the tendon where a gap between the upper and lower portions defines a knee joint, the method further comprising:
causing the knee joint to bend in response to the foot being propelled forward causing the upper and low portions of the leg to move to stimulate the appearance of walking.

16. A method for providing locomotion in a robot that uses lighter than air gas for support and stability having a body that houses control circuitry, an airtight bladder associated with the body that is airtight and is filled with a sufficient amount of lighter than air gas to cause the body to be buoyant in atmospheric air, a set of feet including at least one foot, the combined weight of the set of feet is sufficient to anchor the body to the ground, and a set of legs including at least one leg where each at least one leg connects one foot in the set of feet to the body to anchor the body to ground and allow the body to float at a neutral level, a winch connected to the body, a tether having one end affixed to the winch and a second end affixed to the bladder that is external of the body wherein the winch retracts and extends the tether to cause movement of the body relative the bladder, the method comprising:
reeling in the air bladder using the tether and winch until the air bladder is proximate the body;
releasing the tether using the winch allowing the air bladder to rise until the tether is taunt; and
causing an upward force to be applied to the body and set of legs causing the set of feet connected to the legs to leave the ground giving a jumping effect.
